(19) United States
(12) Patent Application Publication
(10) Pub. No.: US 2025/0381919 A1
(43) Pub. Date: Dec. 18, 2025

(54) VEHICLE SENSOR ASSEMBLY

(71) Applicant: Ford Global Technologies, LLC, Dearborn, MI (US)

(72) Inventor: Michael Robertson, JR., West Bloomfield, MI (US)

(73) Assignee: Ford Global Technologies, LLC, Dearborn, MI (US)

(21) Appl. No.: 18/746,670

(22) Filed: Jun. 18, 2024

(51) Int. Cl. B60R 11/00; B62D 25/06

(52) U.S. Cl. CPC B60R 11/00; B62D 25/06; B60R 2011/004; B60R 2011/0052; B60R 2011/0063

(57) ABSTRACT

A sensor assembly includes a transparent roof panel of a vehicle, the roof panel including a top surface facing upward and a bottom surface facing downward, the roof panel including a cutout spaced from edges of the roof panel and extending through the roof panel from the bottom surface to the top surface; a bracket mounted to and supported by the bottom surface of the roof panel, the bracket covering the cutout; and a sensor supported by the bracket and extending upward from the roof panel. The bracket and the sensor are spaced from roof beams of the vehicle.

### BACKGROUND

Vehicles typically include a variety of sensors. Some sensors detect the position or orientation of the vehicle, for example, global positioning system (GPS) sensors; accelerometers, such as piezo-electric or microelectromechanical systems (MEMS); gyroscopes such as rate, ring laser, or fiber-optic gyroscopes; inertial measurement units (IMU); and magnetometers. Some sensors detect objects external to a vehicle, for example, radar sensors, scanning laser range finders, light detection and ranging (lidar) devices, and image processing sensors such as cameras.

### BRIEF DESCRIPTION OF THE DRAWINGS

FIG. 1 is a perspective view of a portion of an example vehicle with a sensor assembly.

FIG. 2 is an exploded perspective view of the sensor assembly.

FIG. 3 is a perspective view of a bracket of the sensor assembly.

FIG. 4 is a bottom perspective view of the bracket.

FIG. 5 is a cross-sectional perspective view of a portion of the bracket and a roof panel of the sensor assembly.

FIG. 6 is a front cross-sectional view of the sensor assembly.

FIG. 7 is a front cross-sectional view of another example of the sensor assembly.

### DETAILED DESCRIPTION

This disclosure pertains to a sensor assembly for a vehicle with a transparent roof panel. The roof panel includes a cutout through which the sensor extends upward. The sensor assembly includes a bracket that supports the sensor. The bracket is mounted to and supported by a bottom surface of the roof panel. For example, the sensor assembly can include an adhesive strip extending around the cutout and bonding the bracket to the bottom surface of the roof panel. By using the bottom surface, the bracket and the sensor can be installed on the vehicle as a unit from underneath the roof panel, and datum points on the interior of the frame of the vehicle can be used for accurately positioning the sensor assembly during the installation. The use of the bottom surface for support thus facilitates more accurate installation of the sensor assembly, which can help with proper calibration of the sensor. The bracket can also obviate the use of roof beams of the vehicle to support the sensor assembly. Consequently, the sensor assembly can be spaced from the roof beams.

A sensor assembly includes a transparent roof panel of a vehicle, the roof panel including a top surface facing upward and a bottom surface facing downward, the roof panel including a cutout spaced from edges of the roof panel and extending through the roof panel from the bottom surface to the top surface; a bracket mounted to and supported by the bottom surface of the roof panel, the bracket covering the cutout; and a sensor supported by the bracket and extending upward from the roof panel. The bracket and the sensor are spaced from roof beams of the vehicle.

In an example, a full weight of the sensor and the bracket may be supported by the bottom surface of the roof panel.

In an example, the sensor assembly may further include an adhesive strip extending around the cutout, the adhesive strip bonding the bracket to the bottom surface of the roof panel. In a further example, the bracket may include a lip extending outward from the cutout underneath the roof panel, the adhesive strip sitting on the lip.

In another further example, the adhesive strip may extend fully around the cutout.

In another further example, the adhesive strip may be urethane.

In another further example, the adhesive strip may support a full weight of the sensor and the bracket.

In another further example, the roof panel may include a layer of ceramic paint on the bottom surface extending outward from the cutout, and the adhesive strip may be bonded to the ceramic paint.

In an example, the bracket may include a lip extending outward from the cutout underneath the roof panel and a platform extending upward from the lip into the cutout. In a further example, the sensor may be mounted to the platform. In a yet further example, the sensor may be sitting on the platform.

In another yet further example, the sensor may be suspended from the platform.

In another further example, the bracket may include a plurality of tabs contacting an edge of the cutout. In a yet further example, the lip and the platform may be spaced from contacting the roof panel by the tabs.

In another yet further example, the cutout may include an interior surface extending from the bottom surface of the roof panel to the top surface of the roof panel, each tab may include a first surface and a second surface forming a corner, each first surface may contact the interior surface of the cutout, and each second surface may contact the bottom surface of the roof panel.

In an example, the sensor assembly may further include a trim cover attached to the bottom surface of the roof panel and covering an underside of the bracket.

In an example, the sensor assembly may further include an exterior cover attached to the top surface of the roof panel and covering the sensor. In a further example, the exterior cover may be sealed to the top surface of the roof panel.

With reference to the Figures, wherein like numerals indicate like parts throughout the several views, a sensor assembly 105 includes a transparent roof panel 110 of a vehicle 100, the roof panel 110 including a top surface 115 facing upward and a bottom surface 205 facing downward, the roof panel 110 including a cutout 210 spaced from edges of the roof panel 110 and extending through the roof panel 110 from the bottom surface 205 to the top surface 115; a bracket 215 mounted to and supported by the bottom surface 205 of the roof panel 110, the bracket 215 covering the cutout 210; and a sensor 120 supported by the bracket 215 and extending upward from the roof panel 110. The bracket 215 and the sensor 120 are spaced from roof beams 125 of the vehicle 100.

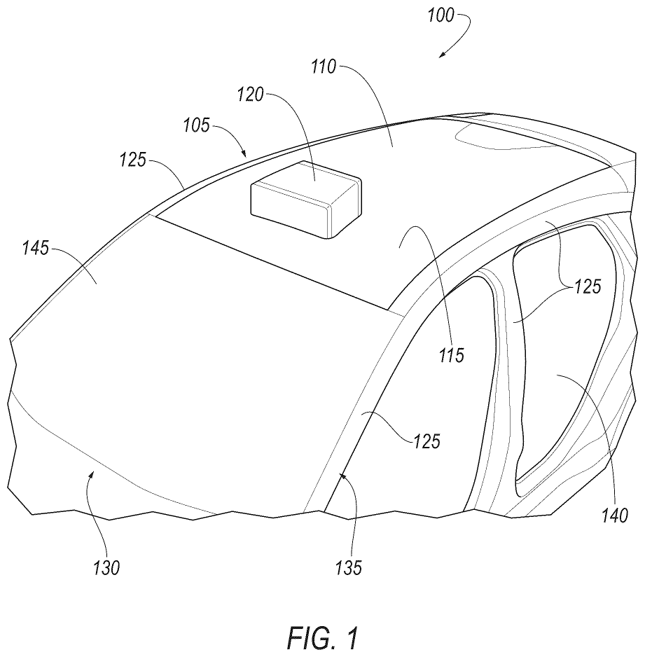

With reference to FIG. 1, the vehicle 100 may be any passenger or commercial automobile such as a car, a truck, a sport utility vehicle, a crossover, a van, a minivan, a taxi, a bus, etc. The vehicle 100 includes the sensor assembly 105.

The vehicle 100 includes a body 130 and a frame 135. The vehicle 100 may be of a unibody construction, in which the frame 135 and the body 130 of the vehicle 100 are a single component. The vehicle 100 may, alternatively, be of a body-on-frame construction, in which the frame 135 supports the body 130 and the body 130 is a separate component from the frame 135. The frame 135 and the body 130 may be formed of any suitable material, for example, steel, aluminum, etc.

The frame 135 includes the roof beams 125, which may also be referred to as roof frame members. The roof beams 125 may extend longitudinally relative to the vehicle 100, e.g., roof rails along the left and right edges of the roof panel 110 above doors of the vehicle 100, and/or the roof beams may extend laterally relative to the vehicle 100, e.g., crossbeams extending from one roof rail to the other roof rail (not shown). The roof beams 125 may be steel, aluminum, carbon fiber, or any other suitable material. The roof beams 125 may support the roof panel 110.

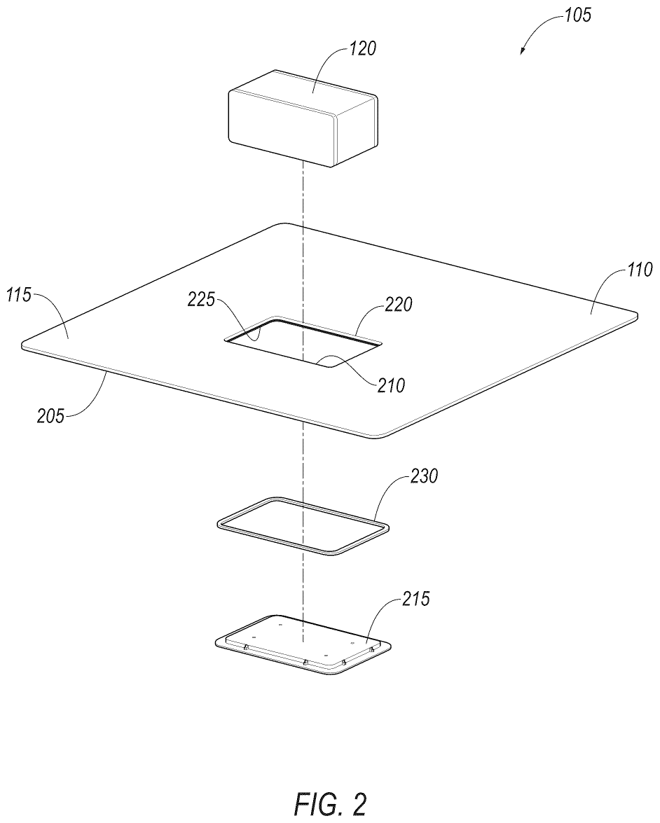

The roof panel 110 extends above the passenger compartment 140 and serves as a topmost structure of the passenger compartment 140. The roof panel 110 extends between two or more of the roof beams 125 and is supported by the roof beams 125. The roof panel 110 extends rearward from a windshield 145 of the vehicle 100. The roof panel 110 may be a separate panel from the windshield 145 or may be a continuation of the windshield 145. The roof panel 110 is transparent, i.e., permits visible light to pass through without noticeable distortion. The roof panel 110 may be formed of any suitably durable transparent material, including glass such as laminated, tempered glass or plastic such as Plexiglas® or polycarbonate. The roof panel 110 includes the top surface 115 facing upward, i.e., vertically away from the vehicle 100, and the roof panel 110 includes the bottom surface 205 facing downward (shown in FIGS. 2 and 5-7), i.e., into the passenger compartment 140.

The sensor 120 may be an environmental sensor, i.e., a sensor that detects the external world, e.g., objects and/or characteristics of surroundings of the vehicle 100, such as other vehicles, road lane markings, traffic lights and/or signs, road users, etc. For example, the sensor 120 may be a radar, an ultrasonic sensor, a scanning laser range finder, a light detection and ranging (lidar) device, or an image processing sensor such as a camera.

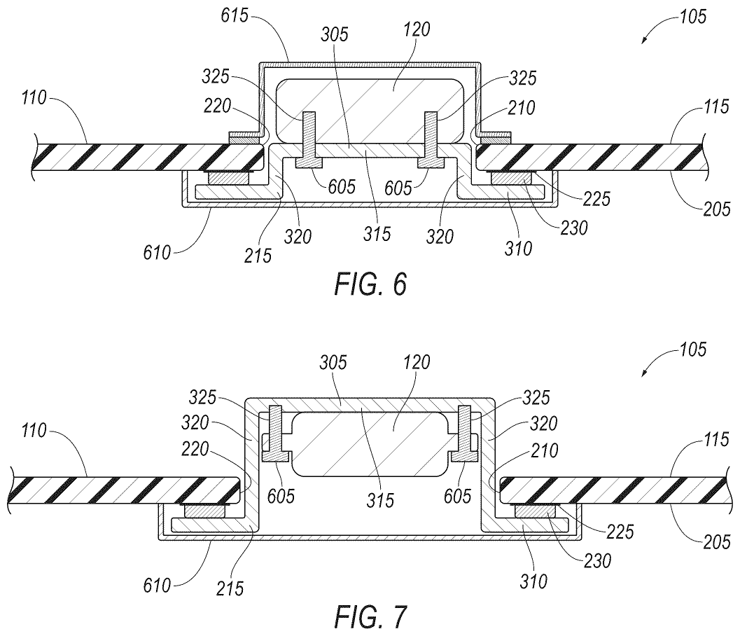

The sensor 120 is positioned at the roof panel 110 with the sensor 120 extending upward from the roof panel 110. This position can provide the sensor 120 with an unobstructed field of view of an area around the vehicle 100. The sensor 120 (as well as the bracket 215, as shown in FIGS. 6-7) is spaced from roof beams 125 of the vehicle 100. The lack of a roof beam 125 extending laterally across the roof panel 110 to support the bracket 215 and the sensor 120 can provide a mostly clear view through the transparent roof panel 110 for occupants of the vehicle 100.

With reference to FIG. 2, the roof panel 110 includes the cutout 210. The cutout 210 defines an opening through the roof panel 110. The cutout 210 extends through the roof panel 110 from the bottom surface 205 to the top surface 115. The cutout 210 includes an interior surface 220 extending from the bottom surface 205 to the top surface 115. The cutout 210 is spaced from the edges of the roof panel 110, which facilitates the position of the sensor 120 described above. The interior surface 220 may extend completely around the cutout 210. The interior surface 220 circumscribes the opening defined by the cutout 210.

The sensor assembly 105 may include the roof panel 110, the bracket 215, the sensor 120, ceramic paint 225, an adhesive strip 230, fasteners 605 (shown in FIGS. 6-7), a trim cover 610 (shown in FIGS. 6-7), and an exterior cover 615 (shown in FIG. 6).

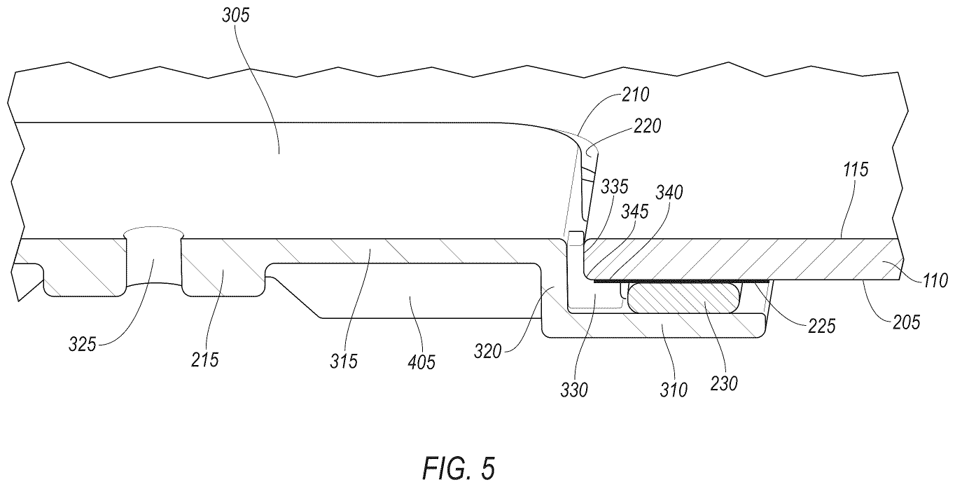

The bracket 215 may have a generally planar shape, i.e., lengths in two dimensions that are significantly greater than a length in the third dimension, in this case, a length along a longitudinal axis of the vehicle 100 and a width along a lateral axis of the vehicle 100 that are each significantly greater than a thickness along a vertical axis of the vehicle 100. The shape of the bracket 215 viewed from above (i.e., a projection of the shape onto a horizontal plane) corresponds to a shape of the cutout 210, e.g., rectangular. The bracket 215 may cover the cutout 210. The bracket 215 may have a slightly greater length and slightly greater width than the cutout 210 so as to cover the cutout 210. The bracket 215 may be positioned inside of the cutout 210 and below the roof panel 110 (as best seen in FIG. 5).

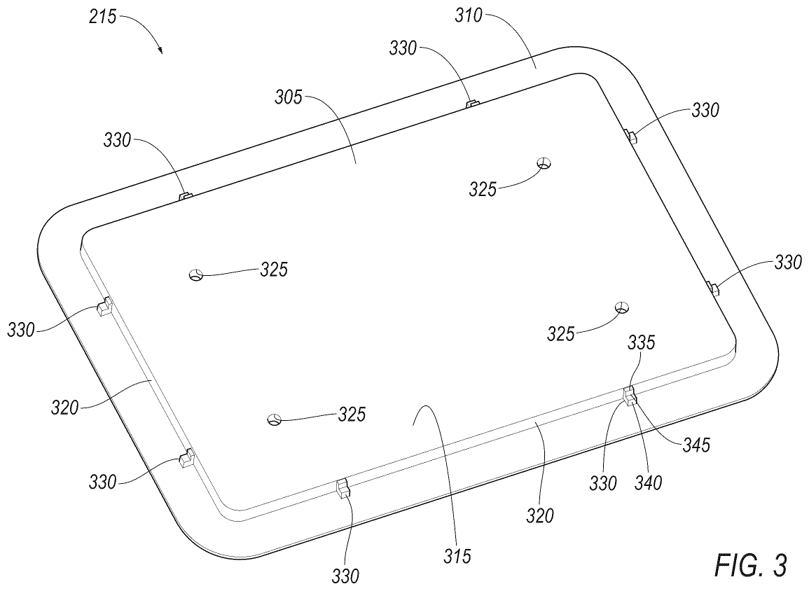

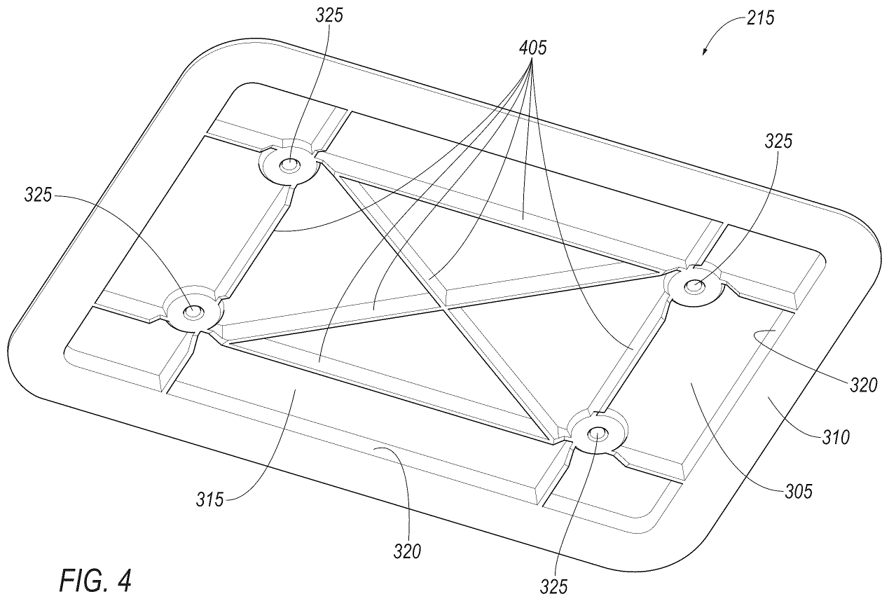

With reference to FIGS. 3-4, the bracket 215 includes a platform 305, a lip 310, and a plurality of tabs 330. The platform 305 extends upward from the lip 310. The platform 305 may include a top panel 315 extending generally horizontally and side panels 320 extending upward from the lip 310 to the top panel 315. The platform 305 provides a mounting area for the sensor 120. The platform 305 may have fastener holes 325 extending through the top panel 315 for receiving the fasteners 605 to attach the sensor 120. As shown in FIGS. 5-7, the platform 305 extends upward into the cutout 210. The platform 305 is sized to fit within the cutout 210. The bracket 215 may include reinforcing ridges 405 extending horizontally along a bottom side of the top panel 315, as shown in FIG. 4, in order to increase the rigidity of the top panel 315 of the platform 305.

The lip 310 extends horizontally outward from the platform 305. The lip 310 extends outward from the cutout 210 underneath the roof panel 110, as seen in FIGS. 5-7. The lip 310 may circumscribe the platform 305. The lip 310 may have a constant width extending horizontally outward from the respective side panels 320. The width of the lip 310 can be chosen to have a horizontal overlap with the roof panel 110 around the cutout 210, to accommodate the adhesive strip 230, as seen in FIGS. 5-7.

Each tab 330 extends upward from the lip 310 and outward from one of the side panels 320 of the platform 305. Each tab 330 includes a first surface 335 and a second surface 340 forming a corner 345. The first surface 335 and the second surface 340 are spaced from the lip 310 and spaced from the platform 305, specifically the side panel 320, by the body of the tab 330. Each first surface 335 faces outward relative to the platform 305, and each second surface 340 faces upward. The bracket 215 may include a plurality of tabs 330, e.g., two tabs 330, on each side panel 320 of the platform 305, for a total of eight tabs 330 given the rectangular shape of the bracket 215.

With reference to FIG. 5, the tabs 330 contact an edge of the cutout 210. Each first surface 335 contacts the interior surface 220 of the cutout 210, and each second surface 340 contacts the bottom surface 205 of the roof panel 110. The tabs 330 serve as spacers to position the bracket 215 relative to the cutout 210. The lip 310 and the platform 305 are spaced from contacting the roof panel 110 by the tabs 330. The tabs 330 space the lip 310 from the bottom surface 205 of the roof panel 110 and space the platform 305 from the interior surface 220 of the cutout 210. Having at least two tabs 330 on each side panel 320 can ensure the proper spacing for each side panel 320.

The roof panel 110 may include a layer of ceramic paint 225 on the bottom surface 205 extending outward from the cutout 210. The ceramic paint 225 may be baked onto the roof panel 110 to increase durability. The ceramic paint 225 forms a stronger bond with the adhesive strip 230 than the glass forming the roof panel 110 would form with the adhesive strip 230. The ceramic paint 225 has a width extending outward from the cutout 210 approximately equal to the width of the adhesive strip 230. The ceramic paint 225 circumscribes the cutout 210.

The adhesive strip 230 sits on the lip 310 below the roof panel 110, i.e., is contacting the lip 310 on a top side of the lip 310. The adhesive strip 230 is sandwiched between, i.e., compressed between, the lip 310 and the roof panel 110 (where the ceramic paint 225 is located). The adhesive strip 230 extends around the cutout 210, e.g., fully around the cutout 210, i.e., circumscribes the cutout 210. The adhesive strip 230 may thus form a loop around the cutout 210. The adhesive strip 230 may be compressed between the lip 310 and the roof panel 110 along a full path length of the adhesive strip 230 around the cutout 210.

The bracket 215 is mounted to and supported by the bottom surface 205 of the roof panel 110, e.g., via the adhesive strip 230. The adhesive strip 230 bonds the bracket 215 to the bottom surface 205 of the roof panel 110. The adhesive strip 230 is bonded to the lip 310 of the bracket 215 below, and the adhesive strip 230 is bonded to the roof panel 110, e.g., to the ceramic paint 225, above. The adhesive strip 230 may be any suitable material for providing a strong bond. In particular, the adhesive strip 230 may be urethane.

With reference to FIGS. 6-7, the sensor 120 is supported by the bracket 215 and extends upward from the roof panel 110. The sensor 120 is mounted to the platform 305, e.g., to the top panel 315 of the platform 305. The sensor 120 may be mounted to the platform 305 by the fasteners 605, e.g., bolts, screws, etc. For example, the sensor 120 may sit on the platform 305, as shown in FIG. 6. The sensor 120 extends upward from the top panel 315 of the platform 305, and the fasteners 605 may extend upward through the top panel 315 into the sensor 120. For another example, the sensor 120 may be suspended from the platform 305, as shown in FIG. 7. The sensor 120 may extend downward from the top panel 315 of the platform 305, and the fasteners 605 may extend through the sensor 120 upward into the top panel 315.

The sensor 120 is supported by the bracket 215, and the bracket 215 in turn is supported by the bottom surface 205 of the roof panel 110 via the adhesive strip 230. For example, a full weight of the sensor 120 may rest on the bracket 215, either directly as in FIG. 6 or via the fasteners 605 as in FIG. 7. The full weight of the sensor 120 and the bracket 215 may be supported by the bottom surface 205 of the roof panel 110. For example, the adhesive strip 230 may support a full weight of the sensor 120 and the bracket 215. The bracket 215 may be attached solely to the bottom surface 205 of the roof panel 110 via the adhesive strip 230. The adhesive strip 230 may support the bracket 215 in tension, with the weight of the sensor 120 transferred to the adhesive strip 230 via the bracket 215.

The trim cover 610 is attached to the bottom surface 205 of the roof panel 110 and covers an underside of the bracket 215. The trim cover 610 may present an orderly appearance to the occupants of the passenger compartment 140. The trim cover 610 may keep occupants from viewing or handling the fasteners 605, wires (not shown), cleaning systems (not shown), and other components facilitating the operation of the sensor 120. The trim cover 610 may be removable by a technician for servicing the sensor 120.

With reference specifically to FIG. 6, an exterior cover 615 may be attached to the top surface 115 of the roof panel 110 and may cover the sensor 120. The exterior cover 615 may be sealed to the top surface 115 of the roof panel 110. The exterior cover 615 may thus protect the sensor 120 from the external environment. At least a portion of the exterior cover 615 may be transparent with respect to whatever medium the sensor 120 is capable of detecting. For example, if the sensor 120 is a lidar device, then at least a portion of the exterior cover 615 is transparent with respect to visible light at the wavelength generated and detectable by the sensor 120.

Alternatively, with reference specifically to FIG. 7, the platform 305 may protect the sensor 120 from the external environment. The sensor 120 may be sealed inside the platform 305. At least a portion of the platform 305 may be transparent with respect to whatever medium the sensor 120 is capable of detecting.

The disclosure has been described in an illustrative manner, and it is to be understood that the terminology which has been used is intended to be in the nature of words of description rather than of limitation. Terms such as “front,” “forward,” “longitudinal,” “back,” “rearward,” “left,” “right,” “lateral,” “upward,” “downward,” “vertical,” etc., are understood relative to the vehicle 100. The adjectives “first” and “second” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. A sensor assembly comprising:
a transparent roof panel of a vehicle, the roof panel including a top surface facing upward and a bottom surface facing downward, the roof panel including a cutout spaced from edges of the roof panel and extending through the roof panel from the bottom surface to the top surface;
a bracket mounted to and supported by the bottom surface of the roof panel, the bracket covering the cutout; and
a sensor supported by the bracket and extending upward from the roof panel;
the bracket and the sensor being spaced from roof beams of the vehicle.

2. The sensor assembly of claim 1, wherein a full weight of the sensor and the bracket is supported by the bottom surface of the roof panel.

3. The sensor assembly of claim 1, further comprising an adhesive strip extending around the cutout, the adhesive strip bonding the bracket to the bottom surface of the roof panel.

4. The sensor assembly of claim 3, wherein the bracket includes a lip extending outward from the cutout underneath the roof panel, the adhesive strip sitting on the lip.

5. The sensor assembly of claim 3, wherein the adhesive strip extends fully around the cutout.

6. The sensor assembly of claim 3, wherein the adhesive strip is urethane.

7. The sensor assembly of claim 3, wherein the adhesive strip supports a full weight of the sensor and the bracket.

8. The sensor assembly of claim 3, wherein the roof panel includes a layer of ceramic paint on the bottom surface extending outward from the cutout, and the adhesive strip is bonded to the ceramic paint.

9. The sensor assembly of claim 1, wherein the bracket includes a lip extending outward from the cutout underneath the roof panel and a platform extending upward from the lip into the cutout.

10. The sensor assembly of claim 9, wherein the sensor is mounted to the platform.

11. The sensor assembly of claim 10, wherein the sensor is sitting on the platform.

12. The sensor assembly of claim 10, wherein the sensor is suspended from the platform.

13. The sensor assembly of claim 9, wherein the bracket includes a plurality of tabs contacting an edge of the cutout.

14. The sensor assembly of claim 13, wherein the lip and the platform are spaced from contacting the roof panel by the tabs.

15. The sensor assembly of claim 13, wherein the cutout includes an interior surface extending from the bottom surface of the roof panel to the top surface of the roof panel, each tab includes a first surface and a second surface forming a corner, each first surface contacts the interior surface of the cutout, and each second surface contacts the bottom surface of the roof panel.

16. The sensor assembly of claim 1, further comprising a trim cover attached to the bottom surface of the roof panel and covering an underside of the bracket.

17. The sensor assembly of claim 1, further comprising an exterior cover attached to the top surface of the roof panel and covering the sensor.

18. The sensor assembly of claim 17, wherein the exterior cover is sealed to the top surface of the roof panel.
